(19) United States
(12) Patent Application Publication
(10) Pub. No.: US 2024/0386451 A1
(43) Pub. Date: Nov. 21, 2024

(54) SYSTEMS AND METHODS FOR PROVIDING OPTIMIZED CUSTOMER FALLOUT FRAMEWORK

(71) Applicant: Accenture Global Solutions Limited, Dublin 4 (IE)

(72) Inventors: Gurpreet SINGH BAWA, Chandigarh (IN); Souvik CHAKRABORTY, Kolkata (IN)

(73) Assignee: Accenture Global Solutions Limited, Dublin 4 (IE)

(21) Appl. No.: 18/319,838

(22) Filed: May 18, 2023

(51) Int. Cl. G06Q 30/0202; G06F 40/289; G06Q 30/0204

(52) U.S. Cl. CPC G06Q 30/0202; G06F 40/289; G06Q 30/0204

(57) ABSTRACT

Systems and methods for providing an optimized customer fallout framework are disclosed. A system receives an input from a user via a digital platform, processes the input and historical data to extract a set of quantifiable features, determines an engagement stage from a plurality of engagement stages for the user based on the set of quantifiable features and an n-helix multi-dimensional model, and determines, via a deep learning model corresponding to a combination of the engagement stage and an advanced engagement stage, a set of positive drivers for the user to move from the engagement stage to the advanced engagement stage. Further, the system generate a multi-nodal network comprising a plurality of grids and aggregates the plurality of grids to generate a global grid for the determined set of positive drivers. Based on the global grid, the system dynamically generates personalized recommendations for the user.

### BACKGROUND

Conversational Artificial Intelligence (AI) is a set of technologies that enables people to communicate with computer-based information systems in everyday human-like natural language. Conversational Al is typically used with automated messaging and speech-enabled applications to offer human-like interactions between computers and humans. This is achieved by understanding speech and text, comprehending a user's intent, interpreting different languages, and generating responses in a manner that mimics human conversations. The automated messaging and speech enabled-applications may implement chat bots, call bots, voice bots, and virtual assistants that enable communication with applications, websites, and devices via voice, text, touch, or gesture input.

When it comes to user engagement, many users do not feel comfortable communicating with a machine/computer outside of certain discrete situations. A computer system intended to converse with a human is typically considered limiting and frustrating. This has manifested in a deep anger that many users feel when dealing with automated phone systems, or spammed, non-personal emails. Indeed, in the perfect scenario, the user interfacing with the Al conversation system would be unaware that they are speaking with a machine rather than another human.

Further, conventional Al platforms intend to offer solutions to concerns that have been stated or to create a ticket for a complaint that has been raised for future reference. Conventional Al platforms essentially have little or no exposure to user-centric themes that may improve user experience and penetration. Further, conventional Al platforms use rule-based or business-driven static subjects to interact with users, and do not provide tailor-made recommendations to optimize customer fallout.

There is, therefore, a need for systems and methods for addressing at least the above-mentioned problems in existing systems.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system including a processor, and a memory coupled to the processor, where the memory may include processor-executable instructions, which on execution, may cause the processor to receive an input from a user interacting with the system via a digital platform, process the input and historical data associated with the user to extract a set of quantifiable features, determine an engagement stage from a plurality of engagement stages for the user based on the extracted set of quantifiable features and an n-helix multi-dimensional model, determine, via a deep learning model corresponding to a combination of the determined engagement stage and an advanced engagement stage, a set of positive drivers for the user to move from the determined engagement stage to the advanced engagement stage based on the set of quantifiable features, generate a multi-nodal network including a plurality of grids corresponding to each instance identity (ID) for each of the determined set of positive drivers based on the input and the historical data, aggregate the plurality of grids to generate a global grid for each of the determined set of positive drivers, dynamically generate personalized recommendations for the user associated with the input based on the generated global grid, and transmit the personalized recommendations to an agent associated with the digital platform.

In an example embodiment, the input may include at least one of numeric data, textual data, and audio data.

In an example embodiment, the historical data may include unstructured dialogue data from past interactions associated with the digital platform, and portfolio data associated with the user.

In an example embodiment, the memory may include processor-executable instructions, which on execution, may cause the processor to process the input and the historical data by classifying the input and the unstructured dialogue data into an acoustic segment and a transcript segment, converting data in the acoustic segment into textual data, and extracting the set of quantifiable features from the acoustic segment, the transcript segment, and the portfolio data to create an information database.

In an example embodiment, the set of quantifiable features may include at least one of the instance ID, textual utterance, query utterance, converse utterance, age, gender, and average monthly frequency.

In an example embodiment, the n-helix multi-dimensional model may include a plurality of helixes associated with the plurality of engagement stages.

In an example embodiment the memory may include processor-executable instructions, which on execution, may cause the processor to determine the engagement stage by assigning a prospect score to each of the plurality of helixes, the prospect score being indicative of a probability of the user to be part of the engagement stage corresponding to the helix, comparing the prospect scores of each of the plurality of helixes, and identifying the engagement stage for the user corresponding to the helix having a highest prospect score among the prospect scores of each of the plurality of helixes.

In an example embodiment, the n-helix multi-dimensional model may include a variable controller to modify a set of variables associated with each of the plurality of helixes.

In an example embodiment, a number of helixes in the n-helix multi-dimensional model may correspond to a number of engagement stages for the user associated with the digital platform.

In an example embodiment, a number of deep learning models associated with the plurality of engagement stages may correspond to the number of helixes in the n-helix multi-dimensional model.

In an example embodiment, the memory may include processor-executable instructions, which on execution, may cause the processor to select the deep learning model from the number of deep learning models based on the determined engagement stage.

In an example embodiment, the memory may include processor-executable instructions, which on execution, may cause the processor to determine the set of positive drivers by determining beta coefficients for the set of positive drivers, normalizing the beta coefficients across the set of positive drivers, and assigning a priority rank to each of the set of positive drivers based on the normalized beta coefficients.

In an example embodiment, the global grid may summarize information corresponding to each of the determined set of positive drivers in a hierarchical manner.

In an example embodiment, the memory may include processor-executable instructions, which on execution, may cause the processor to record feedback of the user and the agent corresponding to the personalized recommendations, and enable self-learning of the system based on the recorded feedback.

In an example embodiment, the digital platform may be one of a messaging service, an application, or an artificial intelligent user assistance platform.

In an aspect, the present disclosure relates to a method including receiving, by a processor associated with a system, an input from a user interacting with the system via a digital platform, processing, by the processor, the input and historical data associated with the user to extract a set of quantifiable features, determining, by the processor, an engagement stage from a plurality of engagement stages for the user based on the extracted set of quantifiable features and an n-helix multi-dimensional model, determining, by the processor via a deep learning model corresponding to a combination of the determined engagement stage and an advanced engagement stage, a set of positive drivers for the user to move from the determined engagement stage to the advanced engagement stage based on the set of quantifiable features, generating, by the processor, a multi-nodal network comprising a plurality of grids corresponding to each instance ID for each of the determined set of positive drivers based on the input and the historical data, aggregating, by the processor, the plurality of grids to generate a global grid for each of the determined set of positive drivers, dynamically generating, by the processor, personalized recommendations for the user associated with the input based on the generated global grid, and transmitting, by the processor, the personalized recommendations to an agent associated with the digital platform.

In an example embodiment, the method may including determining, by the processor, the engagement stage for the user by assigning, by the processor, a prospect score to each of the plurality of helixes, the prospect score being indicative of a probability of the user to be part of the engagement stage corresponding to the helix, comparing, by the processor, the prospect scores of each of the plurality of helixes, and identifying, by the processor, the engagement stage for the user corresponding to the helix having a highest prospect score among the prospect scores of each of the plurality of helixes.

In an example embodiment, the method may include selecting, by the processor, the deep learning model from the number of deep learning models based on the determined engagement stage.

In an example embodiment, the method may include determining, by the processor, the set of positive drivers by determining, by the processor, beta coefficients for the set of positive drivers, normalizing, by the processor, the beta coefficients across the set of positive drivers, and assigning, by the processor, a priority rank to each of the set of positive drivers based on the normalized beta coefficients.

In another aspect, the present disclosure relates to a non-transitory computer-readable medium including machine-readable instructions that may be executable by a processor to perform the steps of the method described herein.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an operating environment or a network architecture for implementing a system for optimizing customer fallout, in accordance with embodiments of the present disclosure.

FIG. 2 illustrates an example block diagram of a system for implementing an optimized customer fallout framework, in accordance with embodiments of the present disclosure.

FIG. 3 illustrates an example representation of components of the system for implementing the optimized customer fallout framework, in accordance with embodiments of the present disclosure.

FIG. 4 illustrates an example representation of an intelligent data foundation engine of the system, in accordance with embodiments of the present disclosure.

FIG. 5 illustrates an example representation of a helix system, in accordance with embodiments of the present disclosure.

FIG. 6 illustrates an example representation of a latent component prioritization engine implemented by the system, in accordance with embodiments of the present disclosure.

FIG. 7 illustrates an example representation of a dense grid construction engine implemented by the system, in accordance with embodiments of the present disclosure.

FIG. 8 illustrates an example detailed representation of the system for optimizing customer fallout, in accordance with embodiments of the present disclosure.

FIG. 9 illustrates an example flow chart of a method for optimizing customer fallout, in accordance with embodiments of the present disclosure.

FIG. 10 illustrates a computer system in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the present disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Conversational artificial intelligence (Al) may refer to a set of technologies that underpin automated messaging and speech-enabled applications that allow computers and humans to interact in human-like ways. Conversational Al platforms have automated bots that may interact with users and effectively reduce call volumes and/or involvement of human assistance. Conventionally, majority of the conversational Al platforms may not be capable of recommending a best course of action to reduce customer churn. Further, conversational flows may be intended to offer solutions to concerns that may have been stated or to create a ticket for a complaint that may have been raised for future reference. For this, the conventional platforms do not provide supplementary targeted recommendations.

To this effect, the present disclosure provides a system for implementing an optimized node fallout framework built upon a collection of mechanism/techniques to improve customer value while improving user experience. In particular, the system may identify the most recent user engagement, which may be subsequently used to identify latent components or factors or features that may have historically helped the user to increase their engagement with a digital platform. Based on the identified latent components, contextual information of these identified latent components may be stored in a global grid accumulator of a multi-nodal network, which may hold universal information for different identified latent components. The multi-nodal network may be used to generate personalized recommendations for the user by passing the universal information to a pre-defined context originator. These personalized recommendations may be passed to an agent associated with the digital platform as an assistance for future interactions with the user.

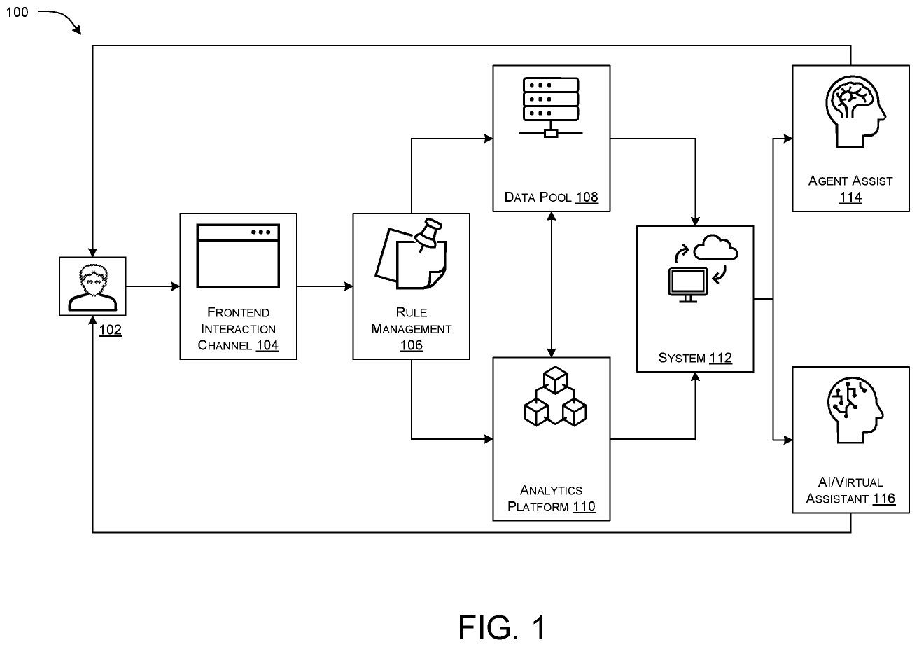

The various embodiments throughout the disclosure will be explained in more detail with reference to FIGS. 1-10.

FIG. 1 illustrates an example operating environment or a network architecture 100 including a system 112 for implementing an optimized node fallout framework, in accordance with embodiments of the present disclosure.

Referring to FIG. 1, the network architecture 100 may include a user 102, a frontend interaction channel 104, a rule management engine 106, a data pool 108, and an analytics platform 110. In an example embodiment, the user 102 may interact with the frontend interaction channel 104. For example, the frontend interaction channel 104 may be a digital platform operating in an augmented reality (AR) or virtual reality (VR) environment, but not limited to the like. In an example embodiment, the user 102 may initiate the interaction with the frontend interaction channel 104 by sending an input. For example, the user 102 may post a query or initiate a conversation with the frontend interaction channel 104 using a computing device (not shown).

In an example embodiment, the computing device may refer to a wireless device and/or a user equipment (UE). It should be understood that the terms “computing device,” “wireless device,” and “user equipment (UE)” may be used interchangeably throughout the disclosure.

A wireless device or the UE may include, but not be limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an example embodiment, the computing device may communicate with the platform 106 via a set of executable instructions residing on any operating system. In an example embodiment, the computing device may include, but are not limited to, any electrical, electronic, electro-mechanical or an equipment or a combination of one or more of the above devices such as VR devices, AR devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from the user 102 such as touch pad, touch enabled screen, electronic pen and the like.

A person of ordinary skill in the art will appreciate that the computing device may not be restricted to the mentioned devices and various other devices may be used by the user 102 for interacting with the frontend interaction channel 104.

Referring to FIG. 1, the frontend interaction channel 104 may communicate with the rule management engine 106 based on the input received from the user 102. For example, the rule management engine 106 may classify an intent of the interaction based on the input received from the user 102. Further, the data pool 108 may consist of all interaction data (historical and present) associated with the frontend interaction channel 104 and the user 102. In addition, the data pool 108 may consist of historical data associated with the user 102. In an example embodiment, the historical data may include, but not be limited to, unstructured dialog data from past interactions associated with the frontend interaction channel 104 and portfolio data associated with the user 102. Furthermore, the analytics platform 110 may consist of backend analytical components for analyzing the interaction data and the historical data associated with the frontend interaction channel 104.

In an example embodiment, the system 112 may determine personalized recommendations to be provided to the user 102 based on the input received from the user 102 and the analyzed data. In an example embodiment, the system 112 may process the input along with the historical data from the data pool 108 associated with the user 102 to extract a set of quantifiable features. Further, the system 112 may determine an engagement stage from a plurality of engagement stages for the user 102 based on the extracted set of quantifiable features and an n-helix multi-dimensional model implemented at the system 112. In an example embodiment, the system 112 may determine, via a deep learning model corresponding to the determined engagement stage, a set of latent components, also referred as positive drivers herein, for the user 102 to move from the determined engagement stage, i.e. current engagement stage, to an advanced engagement stage. Thereafter, the system 112 may generate a multi-nodal network including a plurality of grids corresponding to each instance identity (ID) for each of the determined set of positive drivers based on the input and the historical data. The system 112 may aggregate the plurality of grids to generate a global grid for each of the determined set of positive drivers.

In an example embodiment, the system 112 may dynamically generate the personalised recommendations for the user 102 associated with the input based on the generated global grid. In an example embodiment, the global grid may include universal information for each of the determined set of positive drivers in a hierarchical manner. This universal information may be used by a pre-defined context originator (not shown) to generate the personalized recommendations for the user 102.

The system 112 may transmit the generated personalized recommendations to an agent 114 or a virtual assistant 116 or both for assistance in further interactions with the user 102 via the frontend interaction channel 104.

In an example embodiment, the system 112 may be implemented by way of a single device or a combination of multiple devices that may be operatively connected or networked together. The system 112 may be implemented in a hardware or a suitable combination of hardware and software. In another example embodiment, the system 112 may be implemented as a cloud computing device or any other device that is network connected. In an example embodiment, the system 112 may implement Al and machine learning (ML) prediction algorithm(s) to provide dynamic and accurate recommendations to user queries in a timely manner.

Therefore, the disclosed system 112 may build an intelligent model utilizing unstructured interaction data and portfolio information to automatically identify a user engagement level along with personalized topics or recommendations of engagement enhancement. Further, the disclosed system 112 may receive feedback from the user 102 and the agent 114 to enable self-learning by the system 112 and improve user experience in a seamless manner.

Although FIG. 1 shows exemplary components of the network architecture 100, in other embodiments, the network architecture 100 may include fewer components, different components, differently arranged components, or additional functional components than depicted in FIG. 1. Additionally, or alternatively, one or more components of the network architecture 100 may perform functions described as being performed by one or more other components of the network architecture 100.

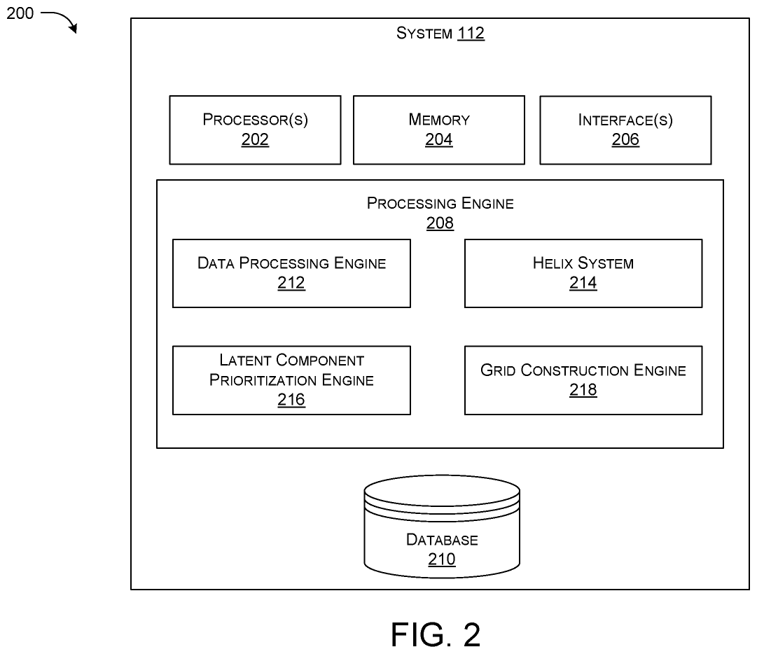

FIG. 2 illustrates an example block diagram 200 of a proposed system 112 for implementing an optimized customer fallout framework, in accordance with embodiments of the present disclosure. It may be appreciated that the system 112 of FIG. 2 may be similar to the system 112 of FIG. 1 in its functionality.

Referring to FIG. 2, the system 112 may include a processor(s) 202, a memory 204, an interface(s) 206, processing engines 208, and a database 210.

In an example embodiment, the processor(s) 202 may be implemented as one or more microprocessors, microcomputers, microcontrollers, edge or fog microcontrollers, digital signal processors, central processing units, logic circuitries, and/or any devices that process data based on operational instructions. Among other capabilities, the processor(s) 202 may be configured to fetch and execute computer-readable instructions stored in the memory 204 of the system 112. The memory 204 may be configured to store one or more computer-readable instructions or routines in a non-transitory computer readable storage medium, which may be fetched and executed to create or share data packets over a network service. The memory 204 may comprise any non-transitory storage device including, for example, volatile memory such as Random-Access Memory (RAM), or non-volatile memory such as Electrically Erasable Programmable Read-only Memory (EPROM), flash memory, and the like.

In an example embodiment, the interface(s) 206 may comprise a variety of interfaces, for example, interfaces for data input and output devices, referred to as input/output (I/O) devices, storage devices, and the like. The interface(s) 206 may facilitate communication for the system 112. The interface(s) 206 may also provide a communication pathway for one or more components of the system 112. Examples of such components include, but are not limited to, the processing engine(s) 208 and the database 210.

The processing engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the system 112 may include the machine-readable storage medium storing the instructions and the processing resource to execute the instructions, or the machine-readable storage medium may be separate but accessible to the system 112 and the processing resource. In other examples, the processing engine(s) 208 may be implemented by electronic circuitry. In an aspect, the database 210 may comprise data that may be either stored or generated as a result of functionalities implemented by any of the components of the processor(s) 202 or the processing engine(s) 208. In an example embodiment, the database 210 may be similar to the data pool 108 of FIG. 1 in its functionality.

Referring to FIG. 2, the database 210 may include one or more data stores for storing information including, but not limited to, interaction data, historical data, portfolio data, recommendations provided by the system 112, etc. In accordance with embodiments of the present disclosure, the database 210 may be continuously updated for every input received from a user (e.g., 102). In an example embodiment, the database 210 may be updated with information from the processing engines 208.

In an example embodiment, the database 210 may integrate with the processing engines 208 in order to remain updated with the latest information corresponding to the interaction data and recommendations provided to the user 102. In an example embodiment, the database 210 may store a feedback received from the user 102 and/or agent (e.g., 114).

Referring to FIG. 2, the processing engine 208 may include one or more engines such as, but not limited to, a data processing engine 212, a helix system 214, a latent component prioritization engine 216, and a grid construction engine 218. In an example embodiment, the processing engine 208 may include a pre-defined context originator. In another example embodiment, the pre-defined context originator may be separate from the system 112. It may be understood that the processing engine 208 may include other engines as appropriate within the scope of the present disclosure.

### Data Processing Engine 212

The data processing engine 212 may refer to an intelligent data foundation system to collect an input from the user, and historical data from the database 210. In an example embodiment, the input may correspond to a conversation initiated by the user 102. The input may include, but not be limited to, numeric data, textual data, and audio data. In an example embodiment, the historical data may include, but not be limited to, unstructured dialog data from past interactions associated with a digital platform (e.g., 104) and portfolio data associated with the user 102. In an example embodiment, the data processing engine 212 may obtain a context and/or an intent associated with the input from a rule management engine (e.g., 106). The data processing engine 212 may create an enriched database for optimizing customer/user fallout.

In an example embodiment, the data processing engine 212 may process the input and the historical data to extract a set of quantifiable features. The data processing engine 212 may classify the input and the unstructured dialog data into an acoustic segment and a transcript segment. Further, the data processing engine 212 may covert data in the acoustic segment into textual data. Then, the data processing engine 212 may extract the set of quantifiable features from, but not limited to, the acoustic segment, the transcript segment, and the portfolio data to create the enriched database. In an example embodiment, the set of quantifiable features may include, but not limited to, instance ID of an interaction of the user 102 with the digital platform 104, textual utterance, query utterance, converse utterance, age, gender, and average monthly frequency. The enriched database may be used by various other components of the system 112 such as the helix system 214, the latent component prioritization engine 216, and the grid construction engine 218.

### Helix System 214

Referring to FIG. 2, the helix system 214 may refer to a system that implements an n-helix multi-dimensional stage identifier model to determine a user engagement stage associated with the digital platform 104. In an example embodiment, the helix system 214 may implement the n-helix multi-dimensional model to determine an engagement stage from a plurality of engagement stages for the user 102 based on the extracted set of quantifiable features from the data processing engine 212.

In an example embodiment, the n-helix multi-dimensional model may include a plurality of helixes associated with the plurality of engagement stages. The helix system 214 may assign a prospect score to each of the plurality of helixes. The prospect score may be indicative of a probability of the user 102 to be a part of the engagement stage corresponding to that helix. Further, the helix system 214 may compare the prospect scores of each of the plurality of helixes. Furthermore, the helix system 214 may identify the current engagement stage for the user 102 corresponding to the helix having a highest prospect score among the prospect scores of each of the plurality of helixes. It may be understood that a number of helixes in the n-helix multi-dimensional model may correspond to a number of engagement stages for the user 102 associated with the digital platform 104.

In an example embodiment, the helix system 214 may include a variable control engine (not shown) to modify a set of variables associated with each of the plurality of helixes. This allows the helix system 214 to be dynamically configurable based on business requirements associated with the digital platform 104.

### Latent Component Prioritization Engine 216

Referring to FIG. 2, the latent component prioritization engine 216 may refer to an engine platform that implements a plurality of deep learning models to identify a set of latent components that positively drive the user 102 to increase their engagement with the digital platform 104 (or business). In an example embodiment, the latent component prioritization engine 216 may determine, via a deep learning model corresponding to a combination of the current engagement stage of the user 102 identified by the helix system 214 and an advanced or higher engagement stage, a set of positive drivers. These set of positive drivers may influence the user 102 to move from the current engagement stage to the advanced engagement stage. In an example embodiment, the latent component prioritization engine 216 may determine the set of positive drivers based on the set of quantifiable features from the data processing engine 212.

In an example embodiment, a number of the deep learning models associated with the plurality of engagement stages correspond to the number of helixes in the n-helix multi-dimensional model implemented by the helix system 214. The latent component prioritization engine 216 may select the deep learning model from the number of deep learning models based on the determined (current) engagement stage of the user 102 to determine the set of positive drivers.

### Grid Construction Engine 218

Referring to FIG. 2, the grid construction engine 218 may refer to an engine that builds a multi-model network of a plurality of grids corresponding to each of the determined set of positive drivers from the latent component prioritization engine 216. In an example embodiment, the grid construction engine 218 may generate the multi-nodal network including the plurality of grids corresponding to each instance ID for each of the set of positive drivers based on the input received from the user 102 and the historical data from the data processing engine 212.

Further, the grid construction engine 218 may aggregate the plurality of grids to generate a global grid for each of the set of positive drivers. In an example embodiment, the global grid summarizes information corresponding to each of the set of positive drivers in a hierarchical manner.

Referring to FIG. 2, the system 112 may use the global grid from the grid construction engine 218 to generate personalized recommendations for the user 102 associated with the input. The system 112 may then transmit the personalized recommendations to an agent (e.g., 114) or a virtual assistant (e.g., 116) for future interactions with the user 102 via the digital platform 104.

In an example embodiment, the system 112 may receive a feedback from at least one of the user 102 and the agent 114 based on the generated personalized recommendations. The system 112 may use the received feedback to self-learn and improve the models including the n-helix multi-dimensional model implemented at the helix system 214 and the deep learning models implemented at the latent component prioritization engine 216 in order to improve user experience and reduce customer fallout.

Although FIG. 2 shows exemplary components of the system 112, in other embodiments, the system 112 may include fewer components, different components, differently arranged components, or additional functional components than depicted in FIG. 2. Additionally, or alternatively, one or more components of the system 112 may perform functions described as being performed by one or more other components of the system 112.

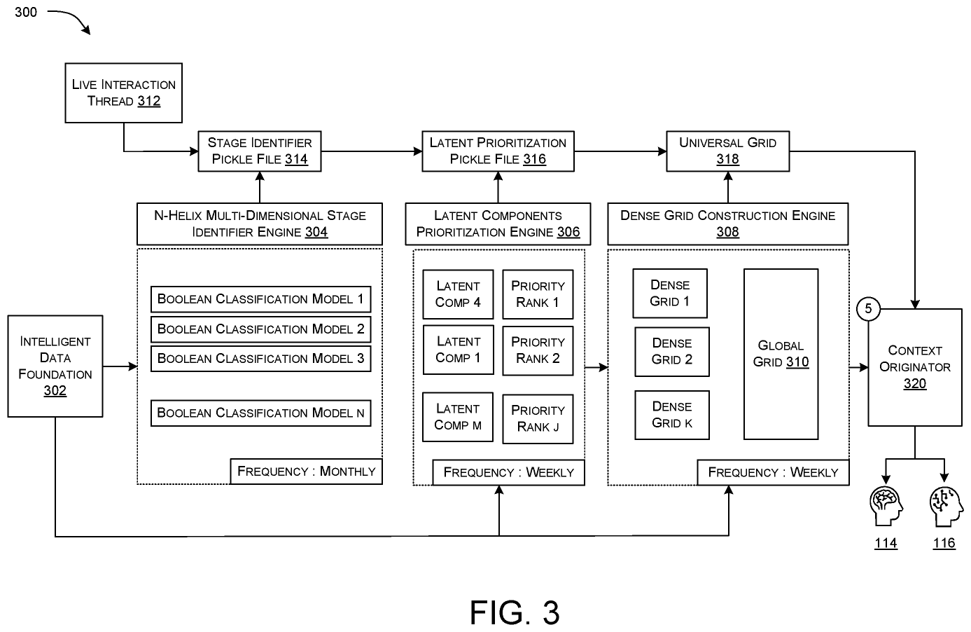

FIG. 3 illustrates an example representation 300 of components of the system 112 for implementing an optimized customer fallout framework, in accordance with embodiments of the present disclosure.

Referring to FIG. 3, the example representation 300 includes an intelligent data foundation system 302, an n-helix multi-dimensional stage identifier engine 304, a latent component prioritization engine 306, a dense grid construction engine 308, and a context originator 320. It may be appreciated that each of the components of FIG. 3 may correspond to the respective components of the system 112 of FIG. 2.

In an example embodiment, the intelligent data foundation system 302 may collect past user-agent interactions. The interaction data may either be in textual format or audio format. In an example embodiment, the interaction data may be numeric data. In order to maintain original characteristics of the original sound wave in the case of audio data, the intelligent data foundation system 302 may retrieve raw aspects of the audio data in a measurable format. In an example embodiment, the intelligent data foundation system 302 may utilize appropriate techniques to covert the audio data in the measurable format. Further, the intelligent data foundation system 302 may convert the audio data into textual format in order to extract contextual information from the audio data. In an example embodiment, the intelligent data foundation system 302 may also consist of portfolio data associated with a user (e.g., 102). As shown in FIG. 3, the intelligent data foundation system 302 may provide the stored data to each of the other components of the system (e.g., 112), i.e., the n-helix multi-dimensional stage identifier engine 304, the latent component prioritization engine 306, and the dense grid construction engine 308.

Referring to FIG. 3, the n-helix multi-dimensional stage identifier engine 304 may implement an n-helix multi-dimensional model. The n-helix multi-dimensional engine 304 may use combined portfolio data from the intelligent data foundation system 302. Additionally, the n-helix multi-dimensional engine 304 may use a set of quantifiable features extracted from the combined portfolio data.

The n-helix multi-dimensional model may include n-helix Boolean classification models, as shown in FIG. 3. It may be understood that a Boolean classification model may refer to a supervised learning algorithm that may categorize data into one of two classes. In the present disclosure, each branch of helix in the n-helix Boolean classification models may be specialized for an engagement stage.

In an example embodiment, the n-helix multi-dimensional stage identifier engine 304 may use the set of quantifiable features to optimize over historical data from the intelligent data foundation system 302. The resulting model may be stored in the cloud as a stage identifier pickle file 314 for real-time grading of users. As an example, any live interaction data 312 mat may pass through the stage identifier pickle file 314 may facilitate identifying a current engagement level for a user. In an example embodiment, the n-helix multi-dimensional stage identifier engine 304 may include a variable control engine (not shown) to enable an administrator with enhanced functionalities of feature/variable tuning associated with each of the helixes.

Following the identification of the user engagement stage at the n-helix multi-dimensional stage identifier engine 304, this information may be used to create a prioritization hybrid framework at the latent component prioritization engine 306 to determine latent components that influence historical users to move from a lower engagement stage to a higher engagement stage, thereby minimizing customer fallout. In an example embodiment, the latent component prioritization engine 306 may use data from the intelligent data foundation system 302 to test a universal set of latent components.

In an example embodiment, the latent component prioritization engine 306 may establish a functional form of an equation using a convex combination of artificial networks. Further, contribution of each latent component may be approximated via a polynomial expansion. The contributions may be normalized across the latent components. Further, the latent component prioritization engine 306 may rank the latent components based on the normalized contributions to determine a relative importance of prioritization of the identified latent components. In an example embodiment, the resulting model from the latent component prioritization engine 306 may be stored in the cloud as a latent prioritization pickle file 316 that may be used when the live interaction data 312 is passed through it.

Further, in an example embodiment, each of the identified latent components may be utilized by the dense grid construction engine 308 for individual users to build a distinct dense grid. The dense grid construction engine 308 may construct a dense grid for each latent component identified in the interaction data from the intelligent data foundation system 302. Further, the dense grid construction engine 308 may map each latent component to their corresponding object indicating a functional relationship.

In an example embodiment, the dense grid construction engine 308 may combine the individual grids to create a global grid 310 for the identified latent components from the latent component prioritization engine 306, where edges may signify a strength of the relationship in a network consolidated across multiple user interactions. The dense grid construction engine 308 may pass the information from the global grid 310 to the context originator 320, which may prepare a list of recommendations to be provided to the user 102. In an example embodiment, the resulting global grid information may also be stored in the cloud as a universal grid 318.

Therefore, for any live interaction thread 312, the context originator 320 may utilize the structured models (from 304, 306, and 308) to provide personalized recommendations to the agent 114 and/or the virtual assistant 116 to assist in interaction with the user 102. In an example embodiment, the n-helix multi-dimensional stage identifier engine 304 may be updated monthly, and the latent component prioritization engine 306 and the dense grid construction engine 308 may be updated weekly. It may be appreciated that these frequencies for updating each of the engines may be configurable based on business requirements.

Although FIG. 3 shows exemplary components of the system 112, in other embodiments, the system 112 may include fewer components, different components, differently arranged components, or additional functional components than depicted in FIG. 3. Additionally, or alternatively, one or more components of the system 112 may perform functions described as being performed by one or more other components of the system 112.

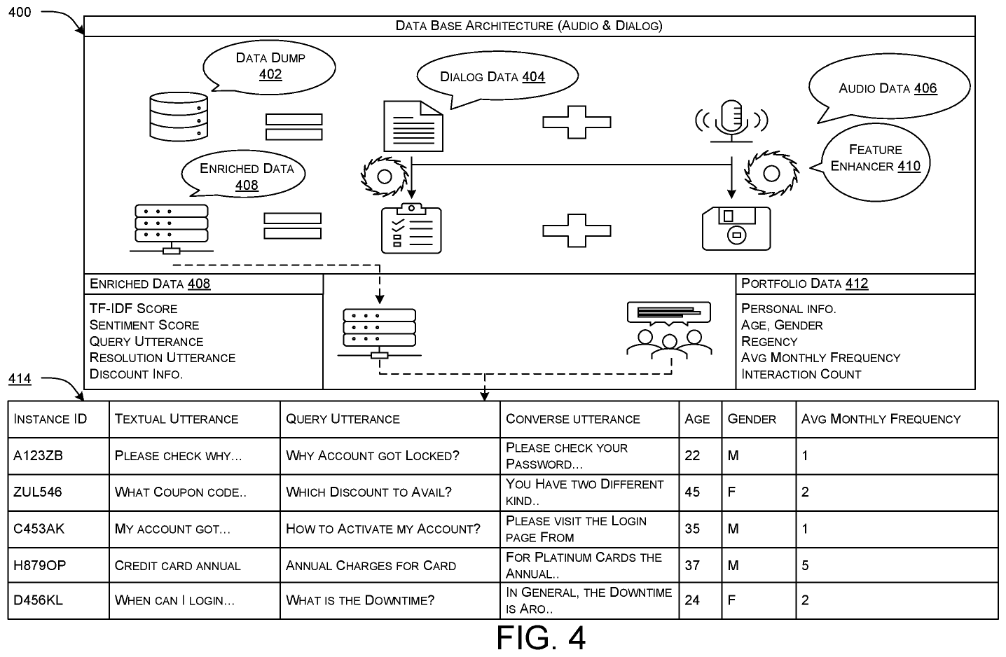

FIG. 4 illustrates an example representation 400 of an intelligent data foundation system or a data processing engine of the system, in accordance with embodiments of the present disclosure.

Referring to FIG. 4, the intelligent data foundation system (e.g., 302 or 212) may collect input received from a user 102 and unstructured dialog data along with user portfolio data from data dump 402 to create an enriched database 414 for optimizing customer fallout. In an example embodiment, the intelligent data foundation system 302 may extract unstructured dialog data 404 from previous interactions in a database (e.g., 108 or 210) and audio data 406. Depending on user's communication mode, the data may be divided into an acoustic segment and a transcript segment. In an example embodiment, a rule management engine (e.g., 106) may be used to handle the dialog data, in order to separate the data into query data and resolution data based on business rules.

In an example embodiment, the intelligent data foundation system 302 may convert the audio data 406 into textual data. The intelligent data foundation system 302 may use the unstructured dialog data 404 and the audio data 406 along with portfolio data 412 to create enriched data 408. In an example embodiment, the portfolio data 412 may include, but not be limited to, personal information associated with the user 102, age, gender, regency, average monthly frequency, and interaction count. Further, in an example embodiment, the enriched data 408 may include, but not be limited to, term frequency-inverse document frequency (TF-IDF) score, sentiment score, query utterance, resolution utterance, and discount information.

In an example embodiment, the intelligent data foundation system 302 may use a feature enhancer 410 to extract a set of quantifiable features from the enriched data 408 and the portfolio data 412 to form an enriched database 414 of the set of quantifiable features. As shown in FIG. 4, the set of quantifiable features may include, but not be limited to, instance ID, textual utterance, query utterance, converse utterance, age, gender, and average monthly frequency.

The enriched database 414 may be used by all the other components of the system 112 to optimize customer fallout.

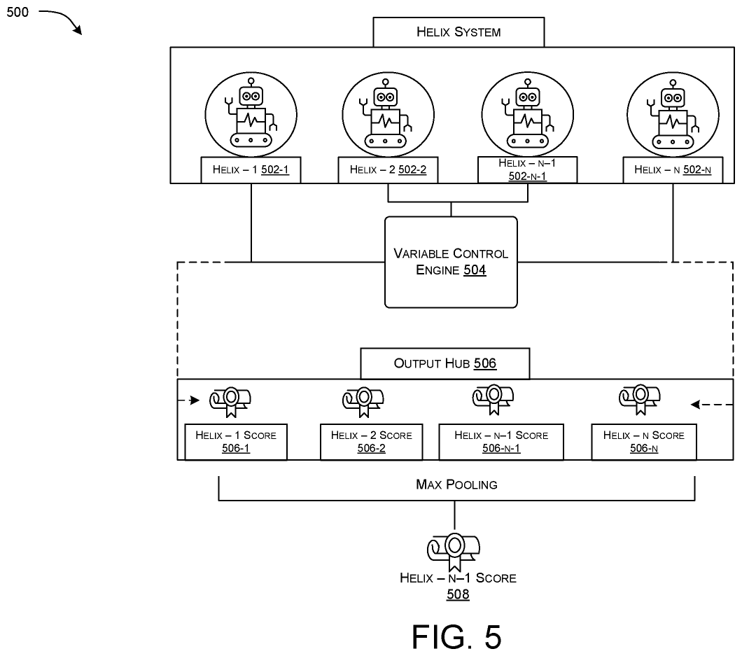

FIG. 5 illustrates an example representation of a helix system 500 implemented by the system for optimizing customer fallout, in accordance with embodiments of the present disclosure. It may be appreciated that the helix system 500 may be similar to the helix system 214 of FIG. 2 and the n-helix multi-dimensional stage identifier engine 304 of FIG. 3 in their functionality.

Referring to FIG. 5, the helix system 500 may include a plurality of helixes (502-1, 502-2 . . . 502-n-1, 502-n), a variable control engine 504, and an output hub 506. In an example embodiment, the helix system 500 may use a set of quantifiable features from the intelligent data foundation system (e.g., 302) to determine a current engagement stage of the user 102. For example, the helix 500 may determine if the user 102 is a frequent user, a loyal consumer, a lifetime member, or the like.

In an example embodiment, the helix system 500 may implement an n-helix multi-dimensional model, as explained herein, where n may represent a number of stages that the user 102 may potentially fall into. Every helix 502 may be independent of each other catering the need of a particular user segment. In an example embodiment, the helix system 500 may include only those many helixes 502 as a number of engagement stages, which may be linear in order O (n) with stage numbers, hence, making fewest number of independent helixes 502 to minimize the operational cost and overall run time associated with the helix system 500. In an example embodiment, each helix 502 may be a Boolean classification model which may specialize to identify one segment, bagging all other segments as one group to optimize customer fallout.

In an example embodiment, the helix system 500 may assign a prospect score to each of the plurality of helix 502 to identify a probability of the user 102 to be a part of that segment or stage corresponding to the helix 502. As shown in FIG. 5, the output hub 506 may include the prospect scores (506-1, 506-2 . . . 506-n-1, 506-n) to each of the helixes 502. In an example embodiment, the helix 500 may compare the prospect scores 506 to identify a maximum score. The helix 502 having the maximum score 506 may indicate that the current engagement level for the user 102. For example, a helix n-1 508 may have the maximum score, and therefore, the user 102 may fall into the engagement stage corresponding to the helix n-1 502-n-1.

Further, as shown in FIG. 5, the helix system 500 may include a variable control engine 504 that may enable an administrator to modify a set of variables associated with each helix 502. This makes the Boolean classification models flexible as compared to traditional ML algorithms. As explained with reference to FIG. 3, the final n-helix structure may be stored in the cloud as a pickle file for live interaction thread (e.g., 312). As an example, in a best case scenario, where all variables may be provided through the variable control engine 504, the run time associated with the helix system 500 may be a unit time, as only one iteration may be required. All the above-explained enhancements in the helix system 500 makes the helix system 500 optimized from operational time and cost perspective, thereby making the system 112 efficient.

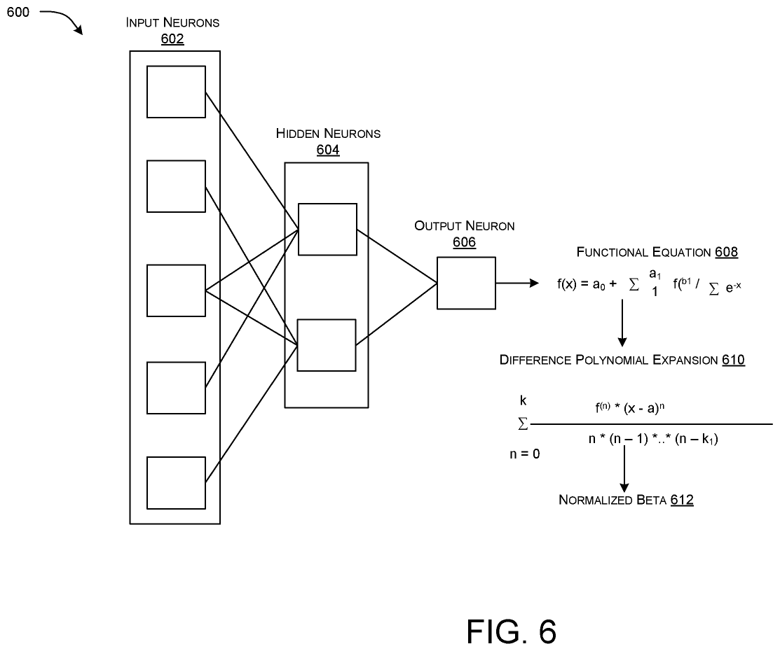

FIG. 6 illustrates an example representation of a latent component prioritization engine 600 implemented by the system for optimizing customer fallout, in accordance with embodiments of the present disclosure. It may be appreciated that the latent component prioritization engine 600 may be similar to the latent component prioritization engines 216 of FIGS. 2 and 306 of FIG. 3.

The latent component prioritization engine 600 may use the set of quantifiable features from the intelligent data foundation system 302 and the determined engagement stage for the user 102 from the helix system 500 to determine a set of positive drivers (or latent components) for the user 102. In an example embodiment, the latent component prioritization engine 600 may determine latent components for each engagement stage pair. Therefore, if there may be n engagement stages under consideration, the latent component prioritization engine 600 may employ n deep learning models to determine the set of positive drivers to facilitate upward movement of the user 102 in terms of engagement with the digital platform 104. For example, if there are 5 engagement stages, then the latent component prioritization engine 600 may have 5 deep learning models, as compared to 5c2=10 in a combinatorial model. This may facilitate reduction in run time from O(n*n) to O(n).

It may be understood that the deep learning models may share a similar architecture. However, the underlying users to optimize deep learning architecture may be tailored for each model. For example, a stage1-stage 2 model may consider only those users who switched from stage 1 (e.g., one timers) to stage 2 (e.g., frequent buyer) in last six months. Therefore, rather than considering the latent components from one engagement stage to all other higher engagement stages, the latent component prioritization engine 600 may focus only on the nearest higher engagement stage, making the system 112 faster and efficient.

Referring to FIG. 6, in an example embodiment, each deep learning model may consist of multiple stages. The first stage (602, 604, and 606) may be a deep learning neural net architecture made by convoluting two log-odds function which may have focused on bagging both linear and non-linear trend in underlying data. Each log-odds method may cater to the linear relationship, and the convolution may cater to the non-linear relationship in the data. In an example embodiment, the latent components under consideration for prioritization may be neurons of the input layer 602. Further, a functional equation 608 may be derived from the previously fitted neural net. The latent component prioritization engine 600 may determine beta coefficients of all the latent components using the functional equation 608. Furthermore, the latent component prioritization engine 600 may transform the neural net's functional equation 608 through difference polynomial expansion 610, which may give an expression in nth degree polynomial form and segregate beta values of the latent components.

In an example embodiment, the latent component prioritization engine 600 may normalize the beta coefficients 612 across all the latent components. The latent component prioritization engine 600 may rank the normalized beta coefficients to determine the set of positive drivers for the user 102. As explained with reference to FIG. 3, the final output from each deep learning model may be stored in the cloud as a pickle file for real time consumption.

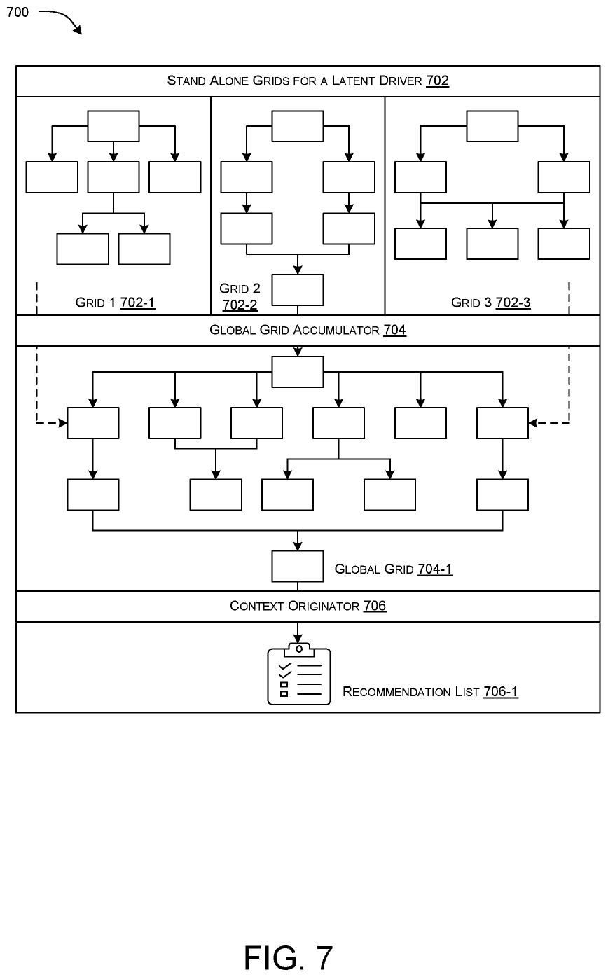

FIG. 7 illustrates an example representation of a dense grid construction engine 700 implemented by the system for optimizing customer fallout, in accordance with embodiments of the present disclosure. It may be appreciated that the dense grid construction engine 700 may be similar to the grid construction engine 218 of FIG. 2 and 308 of FIG. 3.

The dense grid construction engine 700 may use unstructured instance ID level data (e.g., 414) from the intelligent data foundation system 302 to formulate a multi-nodal network 702 of a plurality of grids (702-1, 702-2, 702-3). Although three grids are depicted in FIG. 7, the number of grids may correspond to the number of identified set of positive drivers by the latent component prioritization engine 600. In an example embodiment, the dense grid construction engine 700 may use the ranked set of positive drivers from the latent component prioritization engine 600 to formulate the multi-nodal network 702. Each grid 702 may cater to one instance ID to holistically capture all the data around a particular latent driver. Once all the grids are formulated, a global grid accumulator 704 may aggregate the plurality of grids 702 to generate a global grid 704-1 which may be used by a content originator 706 to generate an output 706-1.

In an example embodiment, the dense grid construction engine 700 may convert interaction chunks into scrubbed text format by lemmatizing raw scripts, followed by separating texts into utterances. Further, the dense grid construction engine 700 may filter the utterances for the driver under consideration, culminating the individual grids 702 for each of the ranked set of positive drivers. Then, the dense grid construction engine 700 may perform a segmentation process for each utterance, which may identify or convert phrases into unimodal sentences for subject-object-action extraction. In an example embodiment, the dense grid construction engine 700 may implement dependency parsing to identify nodes of the grids 702 along with connector object.

Further, the dense grid construction engine 700 may couple all the individual grids 702 to generate the global grid 704-1 via the global grid accumulator 704. Additionally, the dense grid construction engine 700 may integrate an n-tuple conditional probabilistic model to traverse through the global grid accumulator 704 in order to generate relevant details to be provided to the context originator 706. In an example embodiment, each global grid 704-1 may condense all information in a hierarchical manner to be flowed into the context originator 706.

In an example embodiment, the context originator 706 may be a pre-defined set of textual model that may be filled up by the global grid accumulator 704 based on utterance matching to generate a list of personalized recommendations 706-1 for the user 102. Finally, the context originator 706 may pass the list of personalized recommendations 706-1 to the agent 114 or the virtual assistant 116.

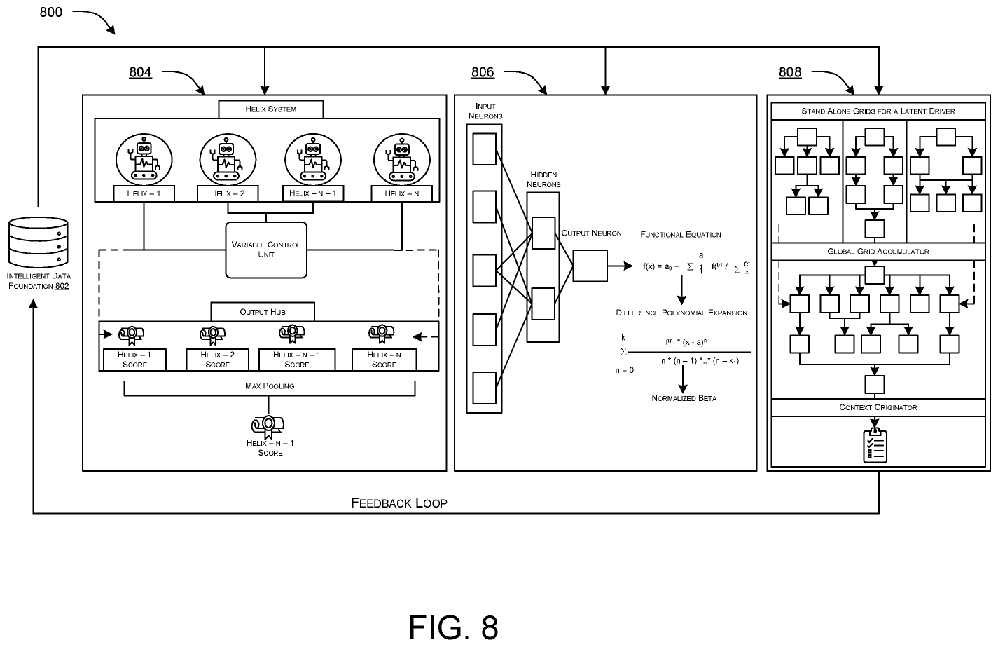

FIG. 8 illustrates an example detailed representation 800 of the system for optimizing customer fallout, in accordance with embodiments of the present disclosure.

The system (e.g., 112) may include the intelligent data foundation system 802, the helix system 804, the latent component prioritization engine 806, and the dense grid construction engine 808, as explained herein with reference to FIGS. 1-7.

Referring to FIG. 8, a feedback loop is indicated from the dense grid construction engine 808 to the intelligent data foundation system 802. In an example embodiment, the present disclosure facilitates self-learning by the system 112 to improve the models and structures implemented at each of the components 804, 806, and 808. The user and/or the agent may provide feedback on the generated personalized recommendations provided by the context originator. This feedback may be fed into the intelligent data foundation system 802 to incorporate the feedback in all the components, thereby making the conversion rate of the overall process a decreasing function and providing more dynamic and efficient conversational Al platform.

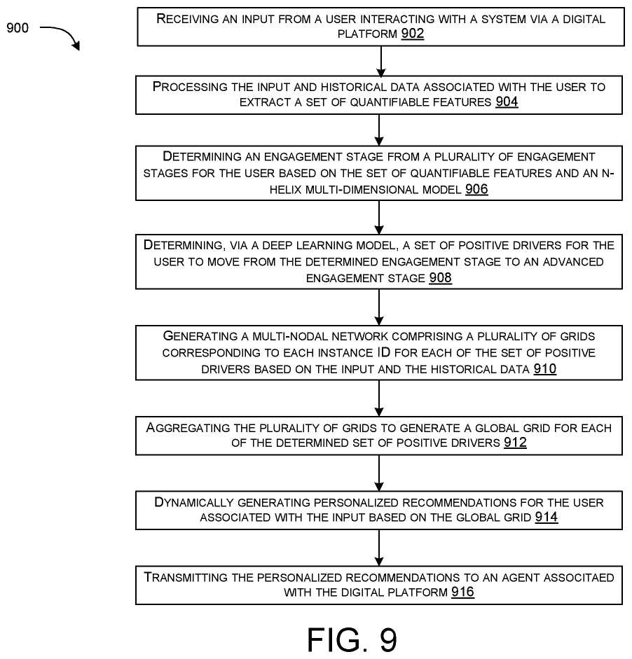

FIG. 9 illustrated an example flow chart of a method 900 for optimizing customer fallout, in accordance with embodiments of the present disclosure.

Referring to FIG. 9, at step 902, the method 900 may include receiving an input from a user interacting with the system 112 via a digital platform 104. In an example embodiment, the input may include, but not be limited to, numeric data, textual data, and audio data. In an example embodiment, the digital platform 104 may be one of: a messaging service, an application, or an artificial intelligent user assistance platform.

At step 904, the method 900 may include processing the input and historical data associated with the user 102 to extract a set of quantifiable features. In an example embodiment, the historical data may include, but not be limited to, unstructured dialogue data from past interactions associated with the digital platform 104, and portfolio data associated with the user 102. Further, the method 900 may include classifying the input and the unstructured dialogue data into an acoustic segment and a transcript segment, and converting data in the acoustic segment into textual data. Furthermore, the method 900 may include extracting the set of quantifiable features from the acoustic segment, the transcript segment, and the portfolio data to create an information database (e.g., 414). In an example embodiment, the set of quantifiable features may include, but not be limited to, the instance ID, textual utterance, query utterance, converse utterance, age, gender, and average monthly frequency.

Referring to FIG. 9, at step 906, the method 900 may include determining an engagement stage from a plurality of engagement stages for the user 102 based on the extracted set of quantifiable features and an n-helix multi-dimensional model implemented by a helix system (e.g., 214 or 306 or 500). In an example embodiment, the n-helix multi-dimensional model may include a plurality of helixes associated with the plurality of engagement stages. Further, the method 900 may include assigning a prospect score to each of the plurality of helixes. The prospect score may be indicative of a probability of the user 102 to be part of the engagement stage corresponding to the helix. Furthermore, the method 900 may include comparing the prospect scores of each of the plurality of helixes, and identifying the engagement stage for the user 102 corresponding to the helix having a highest prospect score among the prospect scores of each of the plurality of helixes. In an example embodiment, the n-helix multi-dimensional model may include a variable controller to modify a set of variables associated with each of the plurality of helixes. Further, a number of helixes in the n-helix multi-dimensional model may correspond to a number of engagement stages for the user 102 associated with the digital platform 104.

Further, at step 908, the method 900 may include determining, via a deep learning model corresponding to a combination of the determined engagement stage and an advanced engagement stage, a set of positive drivers for the user 102 to move from the determined engagement stage to the advanced engagement stage based on the set of quantifiable features. In an example embodiment, a number of deep learning models associated with the plurality of engagement stages corresponds to the number of helixes in the n-helix multi-dimensional model. The method 900 may include selecting the deep learning model from the number of deep learning models based on the determined engagement stage. Further, the method 900 may include determining beta coefficients for the set of positive drivers, and normalizing the beta coefficients across the set of positive drivers. Furthermore, the method 900 may include assigning a priority rank to each of the set of positive drivers based on the normalized beta coefficients.

Referring to FIG. 9, at step 910, the method 900 may include generating a multi-nodal network including a plurality of grids corresponding to each instance ID for each of the determined set of positive drivers based on the input and the historical data. At step 912, the method 900 may include aggregating the plurality of grids to generate a global grid for each of the determined set of positive drivers. In an example embodiment, the global grid may summarize information corresponding to each of the determined set of positive drivers in a hierarchical manner.

Further, at step 914, the method 900 may include dynamically generating personalized recommendations for the user 102 associated with the input based on the generated global grid. At step 916, the method 900 may include transmitting the personalized recommendations to an agent 114 associated with the digital platform 104.

In an example embodiment, the method 900 may further include recording feedback of the user 102 and the agent 114 corresponding to the personalized recommendations, and enabling self-learning of the system 112 based on the recorded feedback.

It may be appreciated that the steps of the method 900 may be performed by the system 112 or in conjunction with the processor 202 and the processing engines 208 within the system 112. It will be appreciated that the steps shown in FIG. 9 are merely illustrative. Other suitable steps may be used to implement the framework, if desired. Moreover, the steps of the method 900 may be performed in any order and may include additional steps.

A person of ordinary skill in the art will readily ascertain that the illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

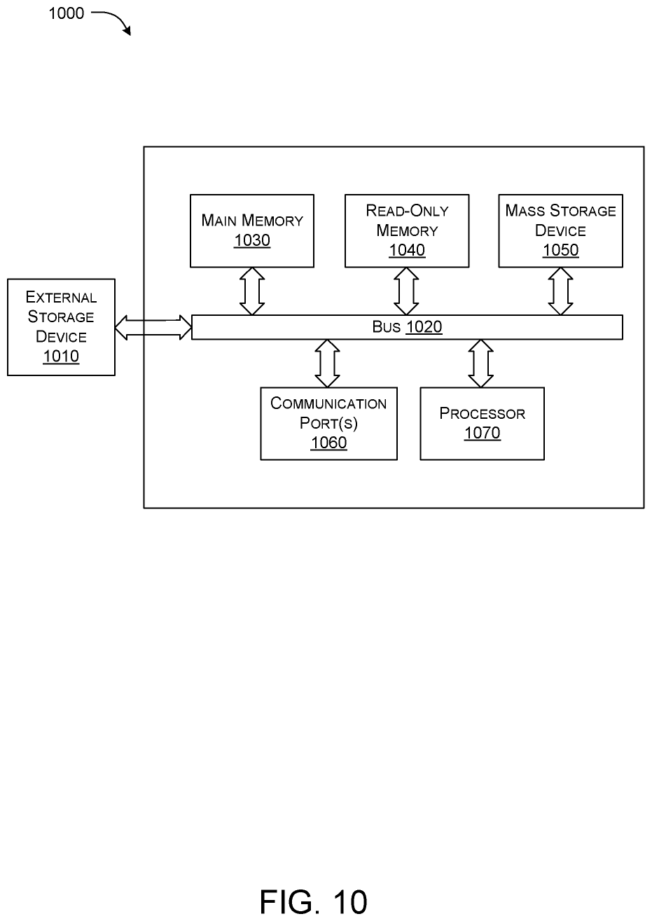

FIG. 10 illustrates a computer system 1000 in which or with which embodiments of the present disclosure may be implemented. In particular, the disclosed system 112 may be implemented as the computer system 1000.

Referring to FIG. 10, the computer system 1000 may include an external storage device 1010, a bus 1020, a main memory 1030, a read-only memory 1040, a mass storage device 1050, communication port(s) 1060, and a processor 1070. A person skilled in the art will appreciate that the computer system 1000 may include more than one processor and communication ports. The communication port(s) 1060 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 1060 may be chosen depending on a network, such a Local Area Network (LAN), Wide Area Network (WAN), or any network to which the computer system 1000 connects. The main memory 1030 may be random access memory (RAM), or any other dynamic storage device commonly known in the art. The read-only memory 1040 may be any static storage device(s) including, but not limited to, a Programmable Read Only Memory (PROM) chips for storing static information e.g., start-up or basic input/output system (BIOS) instructions for the processor 1070. The mass storage device 1050 may be any current or future mass storage solution, which may be used to store information and/or instructions. The bus 1020 communicatively couples the processor 1070 with the other memory, storage, and communication blocks. The bus 1020 can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 1070 to the computer system 1000. Optionally, operator and administrative interfaces, e.g. a display, keyboard, and a cursor control device, may also be coupled to the bus 1020 to support direct operator interaction with the computer system 1000. Other operator and administrative interfaces may be provided through network connections connected through the communication port(s) 1060. In no way should the aforementioned exemplary computer system limit the scope of the present disclosure.

In some embodiments, the method or methods described above may be executed or carried out by the computing system 1000 including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

One of ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

1. A system, comprising:
a processor; and
a memory coupled to the processor, wherein the memory comprises processor-executable instructions, which on execution, cause the processor to:
receive an input from a user interacting with the system via a digital platform;
process the input and historical data associated with the user to extract a set of quantifiable features;
determine an engagement stage from a plurality of engagement stages for the user based on the extracted set of quantifiable features and an n-helix multi-dimensional model;
determine, via a deep learning model corresponding to a combination of the determined engagement stage and an advanced engagement stage, a set of positive drivers for the user to move from the determined engagement stage to the advanced engagement stage based on the set of quantifiable features;
generate a multi-nodal network comprising a plurality of grids corresponding to each instance identity (ID) for each of the determined set of positive drivers based on the input and the historical data;
aggregate the plurality of grids to generate a global grid for each of the determined set of positive drivers;
dynamically generate personalized recommendations for the user associated with the input based on the generated global grid; and
transmit the personalized recommendations to an agent associated with the digital platform.

2. The system of claim 1, wherein the input comprises at least one of: numeric data, textual data, and audio data.

3. The system of claim 1, wherein the historical data comprises unstructured dialogue data from past interactions associated with the digital platform, and portfolio data associated with the user.

4. The system of claim 3, wherein the memory comprises processor-executable instructions, which on execution, cause the processor to process the input and the historical data by:
classifying the input and the unstructured dialogue data into an acoustic segment and a transcript segment;
converting data in the acoustic segment into textual data; and
extracting the set of quantifiable features from the acoustic segment, the transcript segment, and the portfolio data to create an information database.

5. The system of claim 1, wherein the set of quantifiable features comprises at least one of: the instance ID, textual utterance, query utterance, converse utterance, age, gender, and average monthly frequency.

6. The system of claim 1, wherein the n-helix multi-dimensional model comprises a plurality of helixes associated with the plurality of engagement stages, and wherein the memory comprises processor-executable instructions, which on execution, cause the processor to determine the engagement stage by:
assigning a prospect score to each of the plurality of helixes, the prospect score being indicative of a probability of the user to be part of the engagement stage corresponding to the helix;
comparing the prospect scores of each of the plurality of helixes; and
identifying the engagement stage for the user corresponding to the helix having a highest prospect score among the prospect scores of each of the plurality of helixes.

7. The system of claim 6, wherein the n-helix multi-dimensional model comprises a variable controller to modify a set of variables associated with each of the plurality of helixes.

8. The system of claim 5, wherein a number of helixes in the n-helix multi-dimensional model corresponds to a number of engagement stages for the user associated with the digital platform.

9. The system of claim 8, wherein a number of deep learning models associated with the plurality of engagement stages corresponds to the number of helixes in the n-helix multi-dimensional model, and wherein the memory comprises processor-executable instructions, which on execution, further cause the processor to select the deep learning model from the number of deep learning models based on the determined engagement stage.

10. The system of claim 1, wherein the memory comprises processor-executable instructions, which on execution, cause the processor to determine the set of positive drivers by:
determining beta coefficients for the set of positive drivers;
normalizing the beta coefficients across the set of positive drivers; and
assigning a priority rank to each of the set of positive drivers based on the normalized beta coefficients.

11. The system of claim 1, wherein the global grid summarizes information corresponding to each of the determined set of positive drivers in a hierarchical manner.

12. The system of claim 1, wherein the memory comprises processor-executable instructions, which on execution, further cause the processor to record feedback of the user and the agent corresponding to the personalized recommendations; and enable self-learning of the system based on the recorded feedback.

13. The system of claim 1, wherein the digital platform is one of: a messaging service, an application, or an artificial intelligent user assistance platform.

14. A method, comprising:
receiving, by a processor associated with a system, an input from a user interacting with the system via a digital platform;
processing, by the processor, the input and historical data associated with the user to extract a set of quantifiable features;
determining, by the processor, an engagement stage from a plurality of engagement stages for the user based on the extracted set of quantifiable features and an n-helix multi-dimensional model;
determining, by the processor via a deep learning model corresponding to a combination of the determined engagement stage and an advanced engagement stage, a set of positive drivers for the user to move from the determined engagement stage to the advanced engagement stage based on the set of quantifiable features;
generating, by the processor, a multi-nodal network comprising a plurality of grids corresponding to each instance identity (ID) for each of the determined set of positive drivers based on the input and the historical data;
aggregating, by the processor, the plurality of grids to generate a global grid for each of the determined set of positive drivers;
dynamically generating, by the processor, personalized recommendations for the user associated with the input based on the generated global grid; and
transmitting, by the processor, the personalized recommendations to an agent associated with the digital platform.

15. The method of claim 14, wherein the n-helix multi-dimensional model comprises a plurality of helixes associated with the plurality of engagement stages, and wherein determining, by the processor, the engagement stage for the user comprises:
assigning, by the processor, a prospect score to each of the plurality of helixes, the prospect score being indicative of a probability of the user to be part of the engagement stage corresponding to the helix;
comparing, by the processor, the prospect scores of each of the plurality of helixes; and
identifying, by the processor, the engagement stage for the user corresponding to the helix having a highest prospect score among the prospect scores of each of the plurality of helixes.

16. The method of claim 15, wherein a number of helixes in the n-helix multi-dimensional model corresponds to a number of engagement stages for the user associated with the digital platform.

17. The method of claim 16, wherein a number of deep learning models associated with the plurality of engagement stages corresponds to the number of helixes in the n-helix multi-dimensional model, and wherein the method comprises selecting, by the processor, the deep learning model from the number of deep learning models based on the determined engagement stage.

18. The method of claim 14, wherein determining, by the processor, the set of positive drivers comprises:
determining, by the processor, beta coefficients for the set of positive drivers;
normalizing, by the processor, the beta coefficients across the set of positive drivers; and
assigning, by the processor, a priority rank to each of the set of positive drivers based on the normalized beta coefficients.

19. The method of claim 14, wherein the global grid summarizes information corresponding to each of the determined set of positive drivers in a hierarchical manner.

20. A non-transitory computer-readable medium comprising machine-readable instructions that are executable by a processor, associated with a system, to:
receive an input from a user interacting with the system via a digital platform;
process the input and historical data associated with the user to extract a set of quantifiable features;
determine an engagement stage from a plurality of engagement stages for the user based on the extracted set of quantifiable features and an n-helix multi-dimensional model;
determine, via a deep learning model corresponding to a combination of the determined engagement stage and an advanced engagement stage, a set of positive drivers for the user to move from the determined engagement stage to the advanced engagement stage based on the set of quantifiable features;
generate a multi-nodal network comprising a plurality of grids corresponding to each instance identity (ID) for each of the determined set of positive drivers based on the input and the historical data;
aggregate the plurality of grids to generate a global grid for each of the determined set of positive drivers;
dynamically generate personalized recommendations for the user associated with the input based on the generated global grid; and
transmit the personalized recommendations to an agent associated with the digital platform.
